(19) United States
(12) Patent Application Publication
(10) Pub. No.: US 2013/0333451 A1
(43) Pub. Date: Dec. 19, 2013

(54) GAS DELIVERY SYSTEM TO PROVIDE INDUCED PARTIAL SATURATION THROUGH SOLUTE TRANSPORT AND REACTIVITY FOR LIQUEFACTION MITIGATION

(71) Applicants: Michac YEGIAN, Lexington, MA (US); Akram ALSHAWABKEH, Franklin, MA (US)

(72) Inventors: Michac YEGIAN, Lexington, MA (US); Akram ALSHAWABKEH, Franklin, MA (US)

(73) Assignee: NORTHEASTERN UNIVERSITY, Boston, MA (US)

(21) Appl. No.: 13/969,885

(22) Filed: Aug. 19, 2013

Related U.S. Application Data
(63) Continuation of application No. PCT/US12/25714, filed on Feb. 17, 2012.
(60) Provisional application No. 61/444,382, filed on Feb. 18, 2011.

(51) Int. Cl. E02D 3/12; G01N 29/02; C09K 17/00

(52) U.S. Cl. CPC E02D 3/12; C09K 17/00; G01N 29/02
USPC 73/61.78; 405/128.7

(57) ABSTRACT

A system and method for providing a partial level of saturation to a mass of sand, through generation of gas bubbles, as a way to prevent liquefaction during earthquakes. The system includes a solution that is operable to generate gas bubbles and a solution generator that prepares the solution. A conduit delivers the solution to the sand, so that the solution generates the gas bubbles during and after being delivered to the sand. A probe may be used to determine whether the sand is susceptible to liquefaction before the solution is delivered and to assess a change in degree of partial saturation after the solution has been delivered.

### CROSS REFERENCE TO RELATED APPLICATIONS

This application is a continuation of International Application No. US12/25714, filed on Feb. 17, 2012, entitled “Gas Delivery System to Provide Induced Partial Saturation Through Solute Transport and Reactivity for Liquefaction Mitigation”, which claims the benefit of U.S. Provisional Application No. 61/444,382 filed Feb. 18, 2011, entitled “Oxygen Delivery System for Liquefaction and Geo-Environmental Mitigation,” each of which is hereby incorporated by reference herein in its entirety.

### STATEMENT REGARDING FEDERALLY SPONSORED RESEARCH/DEVELOPMENT

The present invention was made with United States government support under Grant No. CMMI-1134940 awarded by National Science Foundation. The United States government has rights in this invention.

### FIELD OF THE INVENTION

Embodiments consistent with the present invention relate generally to systems and methods for delivering gas to areas of sand below the earth's surface, and in particular, for inducing partial saturation of the sand to provide strength against liquefaction in the event of an earthquake.

### BACKGROUND OF THE INVENTION

One of the most devastating causes of damages that an existing structure, such as a house, building, bridge or the like, may suffer during an earthquake is liquefaction of loose saturated sands. Evidence of such destruction has been observed in the past in almost every moderate to large size earthquake. Over the past decade, advancements have been made in understanding the fundamental behavior of liquefiable sands under seismic excitations.

Liquefaction of the ground occurs when a sand layer saturated with water is shaken strongly by an earthquake. Because water is not as compressible as air, the motion of the earthquake decreases a pore volume of the ground causing a sudden rise of pore water pressures that are in excess of normal hydrostatic pressures found in the sand. Liquefaction of fully saturated loose sands results in loss of shearing resistance of the sand leading to dramatic geotechnical slope instability and foundation failures.

For new project sites, if liquefaction is deemed to be a potential problem, a limited number of options are available for site remediation, including soil densification, grouting, installation of sand drains, and pumping air into the ground. Such techniques are often very expensive and their applications are limited to sites where a structure has not yet been built. Further detriments of prior options include limited zones of influence and hydraulic fracturing, and hence changes in the structure of the sand and non-uniform distribution of air. There is an urgent need for cost-effective liquefaction mitigation measures that can be applied in an environmentally friendly way at new sites and more importantly underneath existing structures.

### SUMMARY OF THE INVENTION

According to aspects of the present disclosure, liquefaction mitigation systems and methods involve inducing partial saturation (IPS) in sands in a manner that creates small size gas bubbles, and may do so, without disturbing the in situ stress conditions and density of a sand skeleton. The systems and methods are based on injection of a dissolved, ecofriendly chemical, which reacts and generates gas over time in saturated sand. The technique can be applied safely at a new site as well as underneath existing structures, without causing disturbance and distress to the structure.

Aspects disclosed herein include a system for providing a partial level of saturation to a mass of sand. The system includes a solution that is operable to generate gas bubbles, and a solution generator that prepares the solution. A conduit delivers the solution to sand, so that the solution generates the gas bubbles after being delivered to the sand. In certain embodiments, sand is assessed to determine whether it is susceptible to liquefaction before the solution is delivered to the sand. In some embodiments, the conduit is disposed to deliver the solution to an area of the sand that is expected to be subjected to an earthquake. In particular embodiments, the solution generates the gas bubbles only after the solution is delivered to the sand.

In some embodiments, the solution comprises a mixture of sodium perborate and a liquid. In certain embodiments, the conduit comprises a pipe. In other embodiments, a pump is used to force the solution to the sand. In more embodiments, the solution generator comprises a mixer. In further embodiments, the solution generator comprises a chiller. In some other embodiments, a water storage area is provided to be in communication with the pump and solution generator. In certain embodiments, an extraction well provides water for the solution.

In still further embodiments, the system includes an injection well that includes the conduit. In certain embodiments, the conduit extends beneath an existing structure, such as a building. In other embodiments, the conduit extends beneath a site where a structure will be provided.

According to other aspects of the present disclosure, a method for providing a partial level of saturation to a mass of sand is provided, which includes preparing a solution that generates gas bubbles, and delivering the solution through a conduit to sand so that the gas bubbles are generated after the solution is within the sand. In certain embodiments, before the solution is delivered through the conduit, the sand is assessed to determine whether it is susceptible to liquefaction. In further embodiments, sodium perborate is dissolved in a liquid to create the solution and the solution is forced to flow to the sand by a pump.

In more embodiments, an injection well circulates the solution into the sand followed by using an extraction well to extract at least a portion of the solution from sand. In certain embodiments, the solution is delivered beneath an existing structure, such as a building. In other embodiments, the solution is delivered beneath a site of where a structure will be built.

In further embodiments, the method includes manipulating the delivery of the solution so that a predetermined zone of sand is treated. In still further embodiments, multiple conduits are used to deliver the solution, and the manipulating includes controlling which conduct has solution flowing therethrough. The manipulating may include controlling the rate of flow of the solution.

According to further aspects of the present disclosure, a probe for determining a level of partial saturation in sand is provided, which includes a housing, an actuator that induces vibration to the housing, a chamber inside of the housing that includes a liquid, and a pressure transducer to a measure a decay of pressure of the liquid. In certain embodiments, a flexible sealant is provided around a periphery of the housing. In other embodiments, the housing comprises a first end and a second end, wherein the second end has a conical shape. In further embodiments, a porous material is provided around at least a portion of the chamber. In still further embodiments, the porous material is stone.

### DESCRIPTION OF THE FIGURES

The following figures are presented for the purpose of illustration only, and are not intended to be limiting:

FIG. 1 is a perspective view illustrating schematically a field system for inducing a partial degree of saturation according to an exemplary aspect of the present disclosure;

FIG. 2 is a perspective view illustrating schematically a field system for inducing a partial degree of saturation according to another aspect of the present disclosure;

FIG. 3 is a cross sectional view of a probe according to an aspect of the present disclosure;

FIG. 4 is a side view of an exemplary partially saturated sand element with distributed gas bubbles;

FIG. 5 is a side view of an exemplary cyclic simple shear liquefaction box;

FIGS. 6a and 6b are illustrations of S-wave velocity measurements in fully and partially saturated sand specimens;

FIG. 7 is an illustration of S-wave velocity measurements in a partially saturated sand specimen along different wave paths;

FIG. 8 is an illustration of P-wave velocities versus degree of saturation;

FIG. 9 is a micro image of a partially saturated sand specimen;

FIG. 10 is an illustration of excess pore pressure ratios in fully saturated sands under different shear strain amplitudes;

FIG. 11(a) is a cyclic simple shear strain applied to partially saturated sand specimens;

FIG. 11(b) is a comparison of excess pore pressure ratios for different degrees of saturation;

FIGS. 12(a)-12(d) are illustrations of maximum excess pore pressure ratios measured in partially saturated sand specimens during cyclic simple shear strain tests;

FIG. 13(a) is an exemplary experimental setup for testing long-term sustainability of gas bubbles;

FIG. 13(b) is an illustration of degree of saturation under hydrostatic conditions;

FIG. 13(c) is an illustration of degree of saturation under an upward flow gradient;

FIG. 13(d) is an illustration of degree of saturation under base excitation;

FIGS. 14(a)-14(b) relate to excess pore pressure ratios generated in a partially saturated specimen during a cyclic shear strain test;

FIG. 15 is an illustration of an excess pore pressure ratio generated in a partially saturated sand profile experiencing earthquake excitation;

FIG. 16 (a) is an illustration of a cyclic shear strain record;

FIG. 16(b) is an illustration of an effect of degree of saturation on excess pore pressure ratios;

FIG. 16(c) is an illustration of effects of relative density on excess pore pressure ratios;

FIG. 17 is an illustration of an effect of cyclic shear strain amplitude on excess pore pressure ratios in a partially saturated sand specimen;

FIG. 18 is an illustration of an initial effective stress on maximum excess pore pressure ratios;

FIG. 19 illustrates maximum excess pore pressure ratios for different degrees of saturation and relative densities;

FIGS. 20(a)-20(d) illustrate comparisons of maximum excess pore pressure ratios from laboratory data and model predictions;

FIG. 21(a) is an illustration of model predictions of maximum excess pore pressure ratios in loose sand;

FIG. 21(b) is an illustration of model predictions of maximum excess pore pressure ratios in dense sand;

FIG. 22 is an illustration of normalized excess pore pressure ratios versus normalized numbers of cyclic shear strains;

FIG. 23 is an illustration of estimates of excess pore pressure ratios in partially saturated sands; and

FIG. 24 is an example of an excess pore pressure ratio prediction in partially saturated sands using a model, according to an aspect of the present disclosure.

### DETAILED DESCRIPTION OF EXEMPLARY EMBODIMENTS OF THE INVENTION

Embodiments consistent with the present disclosure provide systems and methods for liquefaction and geo-environmental mitigation that can be applied safely at a new site as well as underneath existing structures, without causing disturbance and distress to the structure. In particular and as described in detail below, the technique involves generation of gas bubbles in loose saturated sand thus inducing partial saturation leading to not only strength gain against liquefaction, but potentially eliminating the occurrence of liquefaction under any size earthquake. Research has demonstrated that once gas bubbles are introduced in sands, according to certain embodiments, it is very difficult for the bubbles to dissipate or be driven out of the sand specimen, even under the application of large hydraulic gradients.

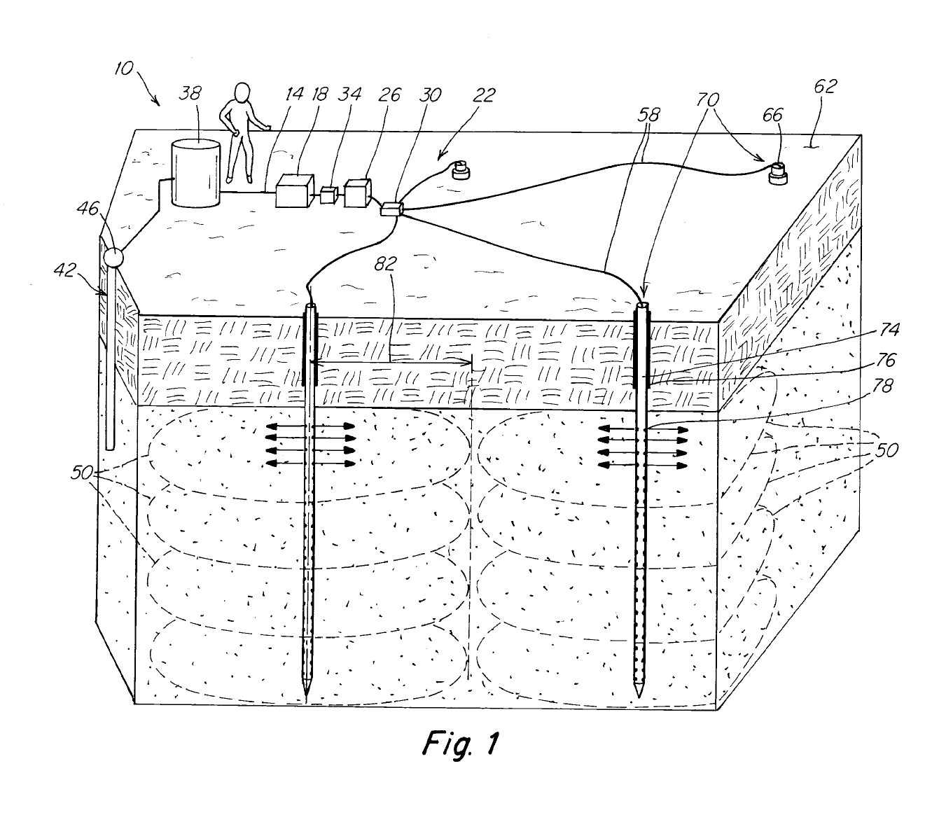

An exemplary aspect of the invention will be described with reference to FIG. 1. A field system 10 for inducing partial degree of saturation includes a source of water 14, a solution generator 18 to prepare a solution, and a distribution system 22. The distribution system 22 includes a compressor 26 and a valve configuration 30 for controlling the distribution. The solution generator 18 may be any suitable device or mixer as is known in the art for creating a solution from a combination of liquids and/or solids. In warm environments, a chiller 34 may be used in conjunction with the mixer to assist in causing a desired chemical reaction.

The source of water 14 may include a water storage container 38, such as a drum or tank. An extraction well 42 may also be used to supply water with the assistance of a pump 46. Even if a well is present, the storage container 38 can be used to keep a reservoir of supply water. Water is fed from the extraction well 42 or the storage container 38 to the solution generator 18 for creating the solution.

The compressor 26 pressurizes the solution for distribution to targets zones of loose sand 50 that is initially liquefiable. As used herein, the term “sand” is intended to be naturally occurring granular material composed of finely divided rock and/or mineral particles. The composition of the sand is highly variable, depending on the local rock sources and conditions, as is known in the art. In terms of particle size, for example, sand particles may range in diameter from coarse sand, sieve #4, (4.75 mm) to fine sand, sieve #200, (0.075 mm). An individual particle in this size range is termed a sand grain.

The valve configuration 30 is used to control the flow of solution from the compressor 26 to the target zones 50. It will be appreciated that the valve configuration 30 may be controlled to regulate the solution flow rate and provide the solution to selected target zones of sand 50. The valve configuration 30 is in communication with a plurality of fluid channels 58. Depending on the application, it is possible that only one fluid channel 58 would be needed. The fluid channels 58 may comprise hose or other suitable liquid transportation lines. In accordance with embodiments of the present disclosure, small sized solution generators 18, compressors 26, and pumps 46 can be used to permit application with minimum intrusion at construction or existing building sites, such as buildings, bridges, fluid storage tanks, dams or any similar engineered structure.

The fluid channels 58 extend along the ground 62 to respective entrance points 66 of injection wells 70. The injection wells 70 extend into the ground 62 to a depth that permits access to the target zones 50, including loose sand that is initially liquefiable. The injection wells 70 may include a pipe or conduit 74 made of polyvinyl chloride, metal, or other suitable material for transporting the solution into the ground 62. In an exemplary embodiment, the pipe 74 has a diameter of 5 cm. It will be appreciated that other diameters can be used depending on the particular implementation.

Embodiments of the disclosed systems and methods use a guide tube 76 that is driven into the ground using, for example, a drop hammer, pneumatic hammer or the like. In some embodiments, the guide tube 76 has a length of 3 to 5 feet and has a diameter that is slightly larger than the diameter of the pipe 74. After the guide tube 76 is inserted into the ground, the inside of the guide tube 76 is cleaned so that the pipe 74 can pass therethrough. The pipe 74 has a cone shaped end so that it can then penetrate the ground to the desired depth. The pipe 74 may also be pushed into the ground using a drop hammer, pneumatic hammer or the like. The pipe 74 may be left in place for future treatment or pulled out and used repeatedly.

The solution is delivered through orifices 78 in the pipe 74 to the target zones of sand 50. The orifices 78 may comprise multiple holes and/or slits located at different locations along the pipe 74 to deliver the solution simultaneously at varying depths within layers of sand. The orifices 78 may be covered with a filter material, such as screen or the like. After the solution is delivered to the target zones 50, gas bubbles are generated within the sand by the solution. In accordance with an embodiment, the generation of gas within the sand has minimal impact on existing stresses and compressibility conditions of the said, thus minimizing distress on existing structures that are supported by the target zone 50.

Multiple injection wells 70 can be provided with overlapping target zones 50 to provide a more uniform degree of saturation within a treated area. Each injection well 70 will provide a zone of partial saturation, including a radius of influence 82. In an exemplary embodiment, the radius of influence is approximately 3 meters. Depending on the size and arrangement of the orifices 78 along the pipes 74, the zone of partial saturation can be tailored to have a predetermined coverage area in horizontal and vertical directions.

In an embodiment, the solution used generates minute oxygen bubbles at a slow enough rate so that the solution has time to extend into the sand and have a large zone of influence. The zone of influence can be approximated for determining the most efficient spacing between the respective entrance points of the wells. For example, the entrance points may be separated by approximately 6 meters. However, this distance can vary based on factors, such as the total area to be treated, pressure at which the solution leaves the pipes 74, the diameter of the pipes 74, the volume of solution passing from the pipes 74 into the ground, and the looseness of the sand. Thus, the solution can be applied in a surgical manner to a limited zone by controlling the depth and radius of influence to avoid treating areas of sand unnecessarily. Computer software may be used to simulate a specific site and assist in defining design parameters.

The extraction and injection wells 42, 70 can be used in a cyclic manner to circulate ground water that has been extracted, converted into the desired solution, and then injected back into the ground. Using an extraction well 42 will reduce the need for transporting water to the site, along with expediting the dispersion process and therefore the generation of gas bubbles, if other water sources are not available. By monitoring the solution concentration in the ground, the level of partial saturation can be determined and controlled for different zones, to provide an optimum concentration and avoid wasting materials.

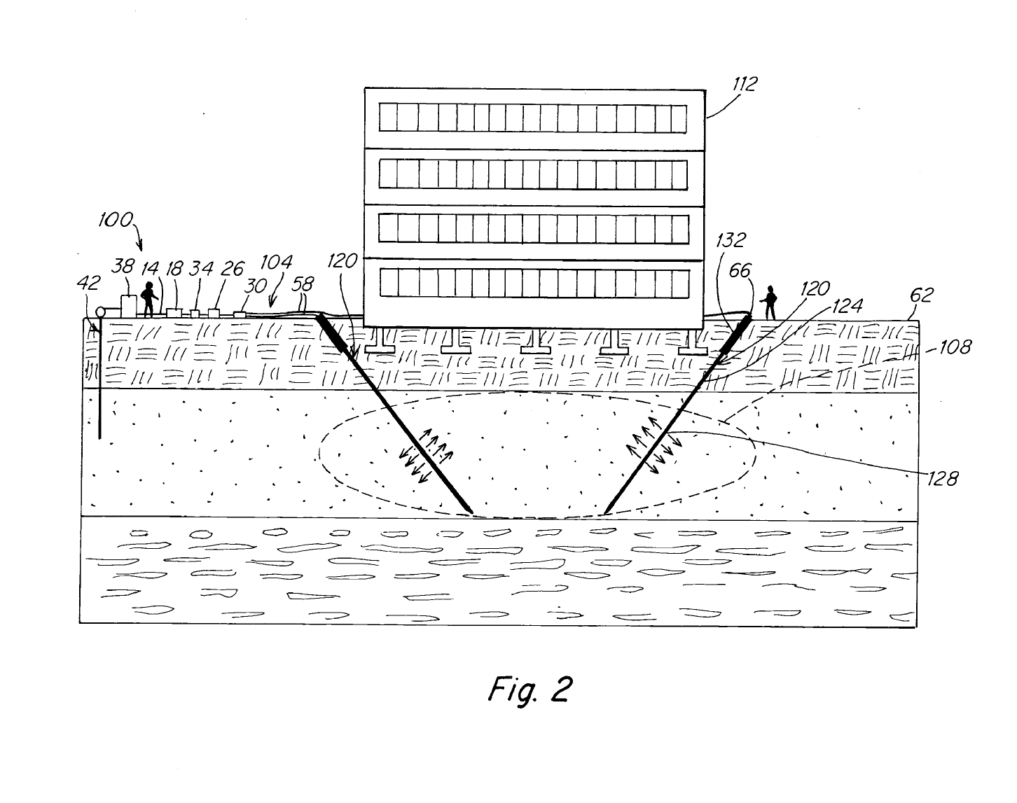

With additional reference to FIG. 2, a further exemplary aspect is illustrated. Similar to the system of FIG. 1, a field system 100 for inducing a partial degree of saturation to sand is provided. The system in FIG. 2 uses the same general components described in FIG. 1, including the water source 14, the solution generator 18, and the chiller 34, if needed. A distribution system 104 of the embodiment in FIG. 2 differs by being specifically disposed to provide solution to target zones 108 positioned beneath an existing structure 112 or beneath a planned site where a structure, bridge, fluid storage tank, dam, building, or any similar engineered structure has not been built, but will be in the future. This is accomplished by creating injection wells 120 to be angled with respect to the structure 112 or to otherwise position the injection wells 120 and pipe or conduit 124 used with the injection wells 120, to extend beneath the structure 112 or planned site. For example, the injection wells 120 may be positioned around a periphery of the structure 112, so that the pipe 124 descends at an angle to reach areas directly beneath the structure 112. Orifices 128 along the pipe 124 can be arranged to provide a unified target zone 108 beneath the structure 112. The number of fluid channels 58 and pipe 124 may vary depending on the existing sand conditions and the structure size. If access permits, the pipe 124 may extend into the ground from an area directly beneath the structure 112 or may extend from an underground level of the structure 112, such as a basement.

Similar to that described in FIG. 1, a guide tube 132 may be used that is driven into the ground. The guide tube 132 may have a length of 3 to 5 feet and a diameter that is slightly larger than the diameter of the pipe 124, for example. After the guide tube 132 is inserted into the ground, the inside of the guide tube 132 is cleaned so that the pipe 124 can pass therethrough. The pipe 124 has a cone shaped end so that it can then penetrate the ground to the desired depth. The pipe 124 may also be pushed into the ground using a drop hammer, pneumatic hammer or the like. The pipe 124 may be left in place for future treatment or pulled out and used repeatedly. The guide tube 132 and the pipe 124 are inserted into the ground at an angle to reach areas beneath an existing structure or areas beneath where a structure will be provided.

Injection and transport of the solution is under low pressure, thus avoiding hydraulic fracturing and not overburdening sand pressures in the vicinity of the pipes 74 and 124. As an example, the pressure of the distributed solution may be 1 psi to 20 psi, for sand that is between 5 feet to 60 feet into the ground. Further, the generation of bubbles through reactivity in the solution is gradual, thus permitting the transport of the solution to distances far from the injection point. The rate of bubble generation of the solution may be close to zero during the first 3 to 6 hours after preparation of the solution. The generation of the bubbles then gradually, exponentially, increases until 80%-85% of the reaction is complete, which may take 2 to 10 days and be affected by the concentration of the solution, pressures within the sand, and temperature. In some embodiments, the concentration of the chemical in the solution may be from 0.1% to 14% by weight, with 14% being the maximum solubility of the chemical. In some other embodiments, the concentration of the chemical may be 0.1% to 0.5% by weight.

A very low concentration of chemical solution generates in situ minute size suspended gas bubbles within the pore space of the sand to prevent the occurrence of liquefaction. The bubble distribution is uniform within the sand, hence the process is a practical preventive measure against liquefaction. There is no change in the structure of the sand, e.g., no change in hydrostatic water pressure, sand stresses, sand bonds or adhesion, and sand compressibility. Therefore, the systems and methods according to embodiments of the invention can be applied at new building sites and more importantly at existing building sites.

In exemplary systems and methods disclosed herein, sodium percarbonate (Na2CO3.3H2O2) is ideally suited for inducing partial saturation of sand. Dissolved sodium percarbonate decomposes and generates minute size oxygen bubbles. Other type of chemicals may be used for generating the gas, such as, for example, sodium perborate, sodium perborate monohydrate, sodium percarbonate monohydrate, hydrogen peroxide, magnesium peroxide, benzenesulfonyl hydrazide, and sodium bicarbonate and the like. Exemplary gases besides oxygen that may be generated include nitrogen and carbon dioxide.

An advantage of using sodium percarbonate for inducing partial saturation of sand is that the generation of oxygen bubbles starts slowly within the first hour of injection. This allows the transport of the solution to extend a large distance from the injection well before the generation of oxygen bubble reduces permeability and the efficiency of injection.

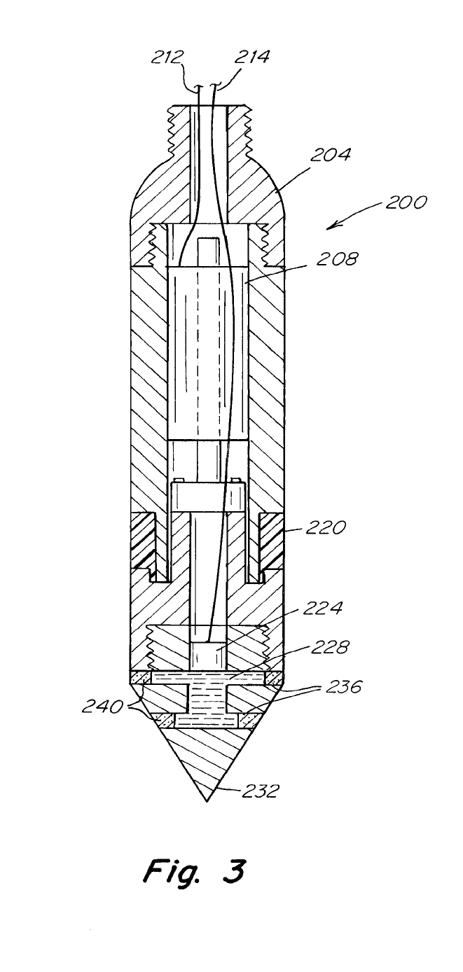

FIG. 3 shows a probe 200 used for testing a saturation level of sand, in accordance with an aspect of the present disclosure. The probe 200 includes an outer housing 204 that encloses a force actuator 208. The housing 204 may be made of metal or other suitable materials. The force actuator 208 is fastened to the housing 204 using screws or the like. The force actuator is activated by a signal sent through a wire 212 that extends to an area outside of the probe 200.

A flexible sealant 220 is circumferentially disposed around the housing 204. A pressure transducer 224 is positioned within the housing 204 and communicates information through a wire 214 that extends to an area outside of the probe 200. A water chamber 228 is disposed between the pressure transducer 224 and a tip 232 of the probe 200. Passageways 236 filled with porous stone 240 surround portions of the water chamber 228. The flexible sealant 220 allows vertical displacement of the tip 232 of the probe 200 while it vibrates, and prevents water infiltration into components of the probe 200.

In operation, the probe 200 is pushed into the ground to a desired depth. The force actuator 208 induces a desired intensity and form of vibration to the tip 232 of probe 200. The pressure transducer 224 measures a rate of generation and subsequent decay of water pressure within the water chamber 228. The probe 200 records water pressures generated while it is driven into liquefiable sand. When the probe 200 is driven into sand that has induced partial saturation, the probe 200 records much smaller water pressures, thus indicating presence of a partial degree of saturation. Accordingly, the probe 200 can determine, indirectly, liquefaction potential, liquefaction strength, degree of sand saturation, in situ sand permeability, and effectiveness of in situ ground improvement measures for earthquake and geo-environmental engineering mitigation.

### Experimental Test Setup

To further evaluate the feasibility of induced partial saturation as a potential field liquefaction mitigation measure, the inventors have conducted experimental research on the cyclic behavior of partially saturated sands.

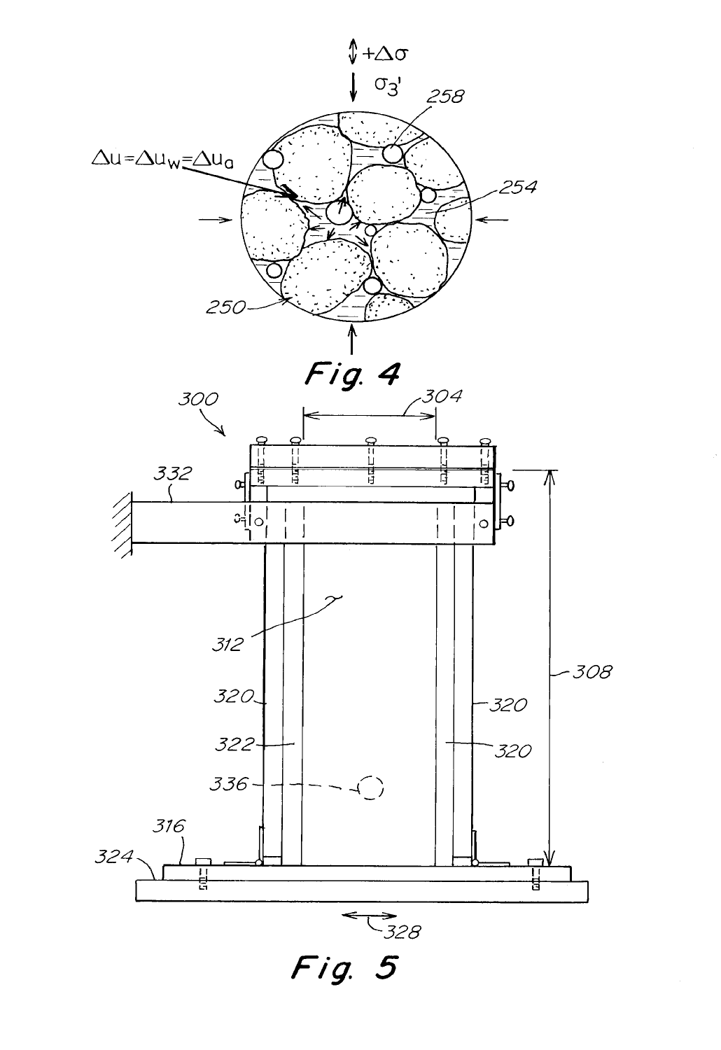

FIG. 4 provides an exemplary illustration of partially saturated sand including sand particles 250, water 254 and bubbles of gas 258. According to an embodiment, the gas bubble size may be between 0.001 mm to completely dry sand where all water in voids is replaced with gas. Saturation of the sand may range from fully saturated where the degree of saturation is 100% to dry sand where the degree of saturation is 0%.

### Pore Pressure Generation in Partially Saturated Sand

During dynamic loading, in fully or partially saturated loose sands, excess pore pressures are developed due to the momentary prevention of water drainage. In such a condition, under dynamic loading, excess air (Δuₐ) and water pressures (Δu_{w}) will be positive and equal to each other since the surface tension between air and water is neglected. A constitutive model is known that relates excess pore pressure (Δu) for one loading cycle as a function of volumetric strain increment and sand parameters in fully saturated sands as shown in Eq. (1).

$$Δ u = \frac{Δ {ɛ}_{vd}}{\frac{1}{{\overline{E}}_{r}} + \frac{{n}_{p}}{{K}_{w}}} \qquad ( 1 )$$

where Δε_{vd}=net volumetric strain increment; Eᵣ=rebound modulus of sand skeleton characteristic; nₚ=porosity of sand; K_{w}=bulk modulus of water. In Eq. (1), excess pore pressure (Δu) depends on the bulk modulus of water (K_{w}) which can be expressed in terms of compressibility (C_{w}) of pore water (C_{w}=1/K_{w}). In partially saturated sands, the pores contain a mixture of water and gas/air bubbles. In such a condition, the compressibility of the pore fluid (C_{aw}) can be expressed as in Eq. (2).

C_{aw}=SC_{w}+(1−S)Cₐ (2)

Eq. (2) implies that the compressibility of the pore fluid depends on the degree of saturation (S) and the compressibility of water (C_{w}) and gas/air (Cₐ). Compressibility of gas/air can be expressed as Cₐ=1/uₐ using Boyle's Law where uₐ is absolute gas/air pressure. Hence, in partially saturated sands Eq. (1) can be expressed as below:

$$Δ u = \frac{{Δɛ}_{vd}}{\frac{1}{{\overline{E}}_{r}} + {n}_{p} [ {SC}_{w} + \frac{( 1 - S )}{{u}_{a}} ]} \qquad ( 3 )$$

Therefore, the excess pore water pressure generated in each loading cycle in partially saturated sand will be less than that in fully saturated sand depending on the degree of saturation (S) and the initial air pressure (uₐ).

Using cyclic simple shear strain tests, the benefit of induced partial saturation against liquefaction were evaluated in terms of excess pore pressure ratio rᵤ=Δu/σ′ᵥ where Δu=excess pore pressure and σ′ᵥ=vertical effective stress. Partially saturated sands never achieve rᵤ=1, as fully saturated sands do. Hence, the selection of the parameter rᵤ for evaluation of cyclic resistance of partially saturated sands, instead of cyclic stresses was deemed most appropriate.

An experimental test setup was devised to conduct cyclic simple shear strain tests on fully and partially saturated sand specimens. The setup included a cyclic simple shear liquefaction box, a 1-D shaking table, a data acquisition system (LabVIEW), and a set of transducers for measuring excess pore pressures, displacements, and shear and compressional wave velocities.

A liquefaction box was designed and built in which fully and partially saturated sand specimens were prepared and tested under cyclic simple shear strains using a shaking table. The box was designed to accommodate a set of transducers, induce uniform shear strains in relatively large sand specimens, and minimize the sidewall boundary effects.

FIG. 5 illustrates a side view of the liquefaction box 300 which is made of Plexiglas and has inside plan dimensions 304 of approximately 19 cm×30 cm and a height 308 of 49 cm. The box 300 includes two side walls 312 that are fixed to a bottom plate 316 and two rotating walls 320 that are hinged also to the bottom plate 316. The connections between the rotating walls 320 with the two fixed walls 312 and the bottom plate 316 are sealed with a flexible joint compound 322, such as Sikaflex 15LM. The sealant makes the joints water tight and allows rotation of the walls 320 through compression and extension of the sealant. Cyclic simple shear strains are induced in the liquefaction box 300 through the use of a shaking table 324. The liquefaction box 300 is fixed on the shaking table 324 with the rotating walls 320 oriented in a direction perpendicular to a direction 328 of the table motion. The top of the rotating walls 320 are fixed to a rigid column 332. Therefore, by moving bottom plate 316 using the shaking table 324, shear strains are induced in sand specimens placed in the liquefaction box 300. Elastic compression and elongation capacity of the joint sealant between the rotating and fixed walls allowed application of up to 1% shear strains.

The adequacy of the design of the liquefaction box 300 with respect to boundary effects was evaluated numerically using a two-dimensional explicit finite difference program called FLAC 5.0. Plan and elevation sections of a sand model in the liquefaction box 300 were investigated under externally applied shear strains. The parameters used in the design were the shear modulus of the sand material, Plexiglas wall elastic modulus, shear modulus and Poisson's ratio of the flexible joint sealant, and cohesion of interface elements to simulate the potential slip between the sand particles and the Plexiglas walls of the box. The results showed that the boundary effects were minimal and the shear strain distribution is uniform down to 8 cm from the bottom plate of the box. Accordingly, pore pressure transducers 336 were placed above this elevation.

The pore pressure transducers 336 were inserted through fittings located on the fixed walls 312 of the liquefaction box 300. The pore pressure transducers 336 were used to measure the hydrostatic as well as the excess pore pressures generated within fully and partially saturated specimens. The cyclic simple shear strain time histories were obtained from the records of two linear variable displacement transducers that measured the relative displacements between the top and bottom of each of the two rotating walls 320. The two records showed identical displacements, thus confirming the box orientation to be perfectly aligned to induce simple shear strains.

Multiple bender elements and bending disks (not shown) were incorporated in the liquefaction box 300 to measure shear wave (S) and compressional wave (P) velocities. The bender elements were used to measure the S-wave velocities to assess uniformity of relative density of the sand specimen. The bending disks were used to measure P-wave velocities as a potential means of determining the degree of saturation of the sand specimen. Because of the relatively large specimen size, 8 bender elements or 8 bender disks were used through multiple wave paths to assess potential variability of the sand parameters within the specimen.

In this experiment, the chemical compound sodium perborate monohydrate (NaBO₃.H₂O) was used to generate oxygen bubbles in sand specimens through its reaction with water. This compound can be readily found in tablet form under the name “EFFERDENT” that produces oxygen bubbles. Sodium perborate monohydrate reacts with water and generates hydrogen peroxide (H₂O₂) which is a ready source of oxygen gas. The chemical reactions are introduced below in Eqs. (4) and (5):

2(NaBO₃.H₂O)+2H₂O→H₂O₂+2BO₃⁻³+2Na⁺+4H⁺ (4)

2H₂O₂→2H₂O+O₂ (5)

Partially saturated specimens were prepared by a wet pluviation technique in which EFFERDENT powder mixed with dry Ottawa sand (ASTM graded C778) was rained into the liquefaction box 300 that was partly filled with water. The sand used was uniform in gradation with coefficient of uniformity (Cᵤ) of 1.1 and D₁₀ of 0.67 mm. The maximum and minimum void ratios of the sand were 0.80 and 0.50 respectively. Partial saturation was created while the chemical reacted in the pore water of the specimen, generating minute oxygen bubbles and displacing the pore water to the surface of the specimen.

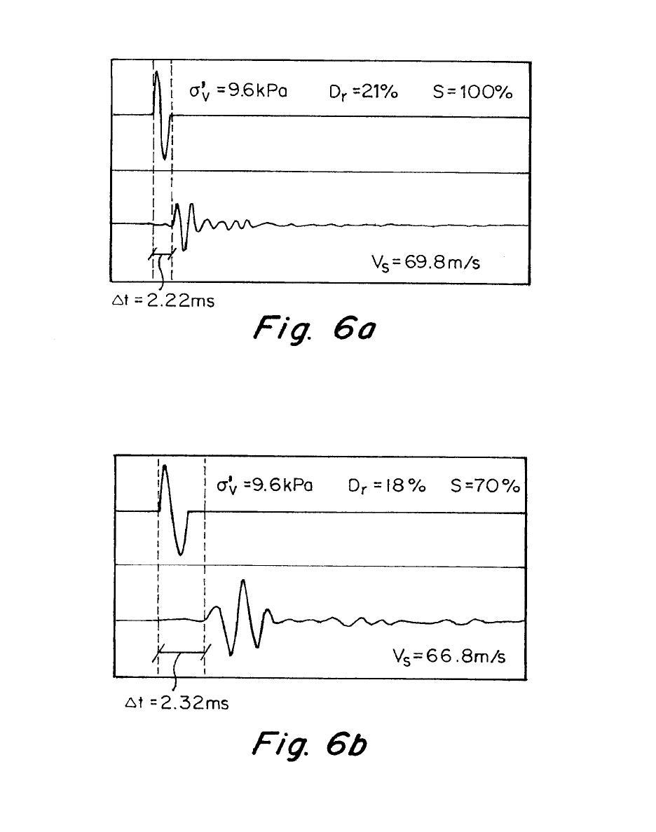

Average values of relative density (Dᵣ) and degree of saturation (S) of the specimen were determined by using phase relation equations. Whether the sample preparation technique adopted indeed resulted in a uniform relative density as well as a uniform degree of saturation was investigated. The bender element setup of the liquefaction box 300 was used to measure S-wave velocities along different wave paths (between two rotating walls and two fixed walls) at two elevations within the specimen. Initial tests were run to demonstrate that shear wave velocity is primarily influenced by sand skeleton and effective stress and not by degree of saturation. By doing so, any differences in shear wave velocity measurements through a specimen could then be attributed to differences in relative density and overburden effective stress. FIGS. 6(a)-6(b) show comparisons of bender element test results between fully (S=100%) and partially saturated (S=70%) sand specimens with similar relative densities of about 20% and under vertical effective stresses of 9.6 kPa. The shear wave velocities in the fully and the partially saturated specimens were similar, 69.8 m/s and 66.8 m/s respectively, thus confirming that S has little effect on the Vₛ.

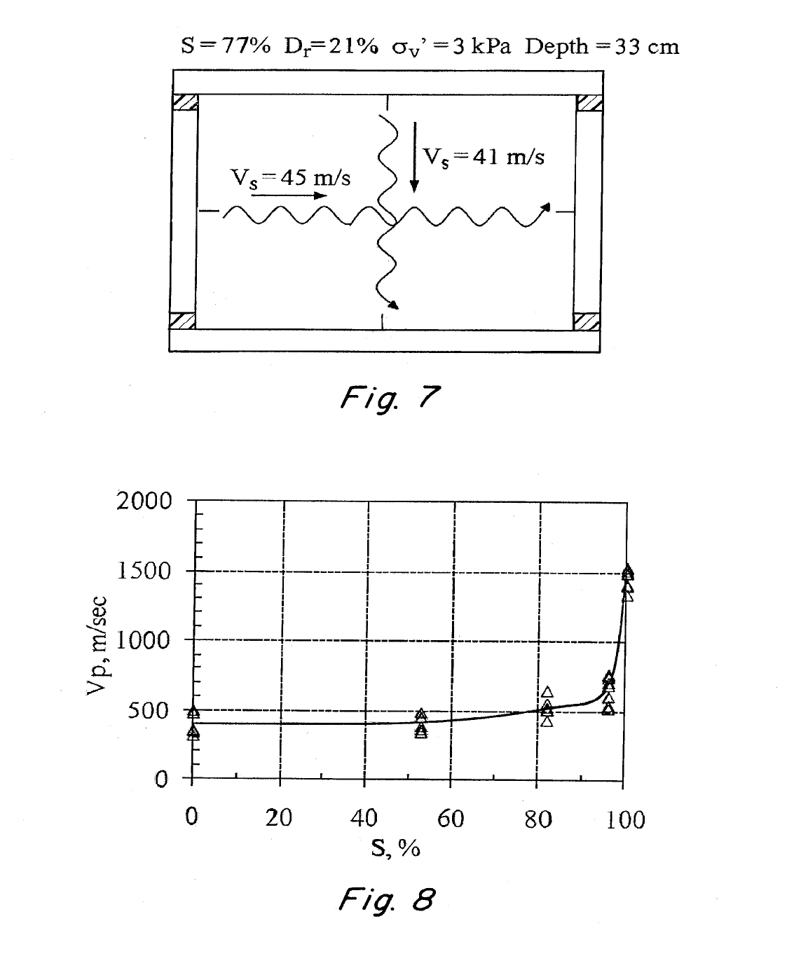

The uniformity of relative density within the partially saturated specimen was then investigated through measurements of Vₛ along different wave paths and at different depths. FIG. 7 shows typical results of Vₛ measurements between rotating (45 m/s) and fixed walls (41 m/s) of the liquefaction box 300 at a depth of 33 cm. Consistency in the measured shear wave velocities along the two different wave paths at the depth of 33 cm confirms uniformity of density within that cross section of the specimen. The Vₛ value measured at a depth of 22 cm (32 m/s) was slightly lower than that at a depth of 33 cm (45 m/s). This can be attributed to the difference in the effective stresses (2 kPa and 3 kPa) between the two depths. These and other similar Vₛ measurements led to the conclusion that the wet pluviation technique of powdered EFFERDENT and dry sand mixture can lead to reasonably uniform density of partially saturated specimens.

The bender disk setup in the liquefaction box 300 was utilized to determine if a P-wave velocity (Vₚ) measurement technique could be used as an indirect determination of degree of saturation (S). P-wave velocities of sand specimens with similar Dᵣ (20-30%) were measured for the range of degree of saturation between 100% (fully saturated) to 0% (dry). FIG. 8 shows the test results which confirm the general thought that Vₚ dramatically decreases when S decreases only slightly from 100% to 96% (from an average of 1460 to 690 m/s). When S decreases from 96% to 0% (dry sand), Vₚ only slightly decreases from 690 m/s to 400 m/s. It is evident that P-wave velocity measurements can indicate presence of partial saturation but cannot be used to determine the specific degree of saturation of a specimen nor the uniformity of partial degree of saturation.

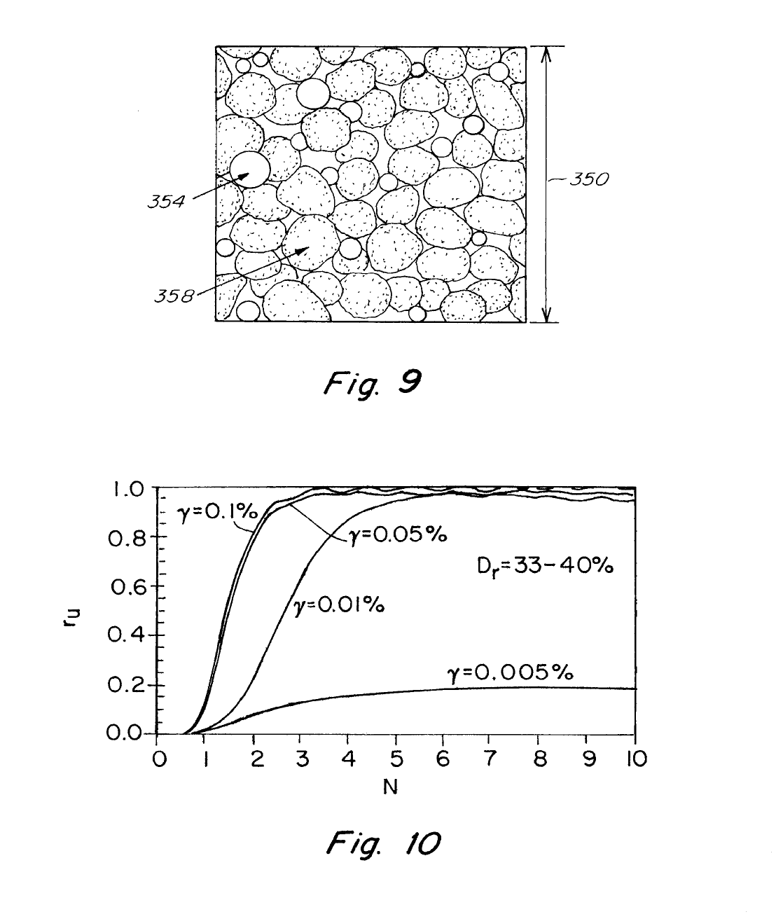

The presence, size, and distribution of oxygen bubbles, hence the uniformity of partial saturation within the sand specimen were investigated by using a high resolution digital camera, a micro lens with a focal distance of 15 cm, and two LED lights. The oxygen bubbles were identified by the reflection of the two LED lights that were pointed at the bubbles. FIG. 9 shows an enlarged digital image, 2.5 mm in length 350, of a partially saturated specimen in which a typical oxygen bubble 354 and sand particle are identified 358. The results of digital imaging led to the findings that generally oxygen bubbles were smaller in size (0.1-0.3 mm in diameter) than the observed void space (0 6 mm in equivalent diameter as observed on the digital image). The average sand particle size was 0.42 mm. To evaluate the uniformity of degree of saturation within the specimen, the distribution of oxygen bubbles in various sections of the specimen were digitally recorded. Using measurement tools known in the art, the degree of saturation in each section was computed by measuring the area of oxygen bubbles and noting the porosity of the specimen. For the example specimen shown in FIG. 9, the degree of saturation computed from the digital image was 77% which was in agreement with average degree of saturation of the specimen that was calculated using phase relations (80%). The results from the digital imaging technique on various specimens confirmed that the degree of saturation within the specimen was generally very uniform.

In summary, shear wave velocity measurements as well as the use of digital imaging techniques confirmed the uniformity of relative density and degree of saturation within a specimen prepared by the wet pluviation method. Therefore, the average values of Dᵣ and S computed using phase relation equations were considered appropriate for use in the interpretation of cyclic simple shear test results from a sand specimen.

Cyclic simple shear strain tests were considered to be most suitable for evaluation of liquefaction response of sands in terms of excess pore pressure ratio rᵤ=Δu/σ′ᵥ. Therefore, cyclic simple shear tests were conducted on fully and partially saturated sand specimens to evaluate the effect of partial saturation on cyclic response.

### Tests on Fully Saturated Sands

Cyclic simple shear strain tests were performed on fully saturated sand specimens to determine the ranges of relative density (Dᵣ), shear strain amplitude (γ), and frequency of the excitation, that would lead to initial liquefaction rᵤₘₐₓ =1.0 and to allow comparisons between fully and partially saturated test results.

Fully saturated sand specimens were prepared by wet pluviation of dry Ottawa sand resulting in a relative density of around 20%. Denser specimens were obtained as a result of each run of cyclic simple shear strain test. At the start of each subsequent test, pore pressures were assured to be hydrostatic. To prevent dissipation of excess pore pressures during cyclic testing, a frequency of 10 Hz was used for the applied cyclic shear strain. In denser specimens tested under low amplitude shear strains, frequency of 20 Hz was used to minimize the duration of the test and potential dissipation of excess pore pressures during testing.

A total of 19 tests were performed on fully saturated sand specimens at Dᵣ=20-90% and under shear strain amplitudes of 0.005%-0.2%. FIG. 10 shows typical test results of excess pore pressure ratio (rₑ) as functions of amplitude and number of cycles of shear strain. Initial liquefaction was achieved only when γ was greater than 0.005%. Also, for a given Dᵣ, the larger the γ, the fewer were the number of cycles required to achieve initial liquefaction. These test results on fully saturated specimens confirmed the adequacy of the test setup, sample preparation, measurements of transducers, and the data acquisition system for use in cyclic simple shear strain testing of partially saturated specimens.

### Tests on Partially Saturated Sands

A total of 96 tests were performed on partially saturated specimens prepared by wet pluviation of EFFERDENT powder and a dry Ottawa sand mixture in the liquefaction box 300. Different degrees of saturation (S>40%) were achieved by varying the mass ratio of EFFERDENT powder to dry sand. In these specimens, initial hydrostatic pore pressures were positive confirming partial saturation without surface tension. It is noted that because of lower permeability of partially saturated specimens compared with fully saturated, a frequency range of 4-10 Hz of the applied cyclic shear strains was adequate to prevent dissipation of excess pore pressures during the tests.

Test results were obtained for Dᵣ=20-67%, γ=0.01-0.2%, and S>40%. FIG. 11(a) shows a cyclic simple shear strain applied to the partially saturated sand specimens. FIG. 11(b) presents a typical set of excess pore pressure generations in the partially saturated specimens as a function of number of cycles of strain application. For a specimen with a specific degree of saturation, as the number of cycles of shear strain increased, excess pore pressures hence rᵤ increased to a maximum value of rᵤₘₐₓ. The number of cycles to reach rᵤₘₐₓ is referred to Nₘₐₓ.

The following observations were made from FIG. 11(b) and other similar test results:
1—While fully saturated specimens achieve initial liquefaction (rᵤₘₐₓ=1.0), partially saturated sand specimens never achieve initial liquefaction (rᵤₘₐₓ<1.0).
2—For a given strain and relative density, rᵤₘₐₓ decreases with reduction in degree of saturation (S).
3—Larger Nₘₐₓ was observed in specimens with lower degrees of saturation.
4—Depending on the number of applied cycles of shear strain (N), rᵤ can be significantly less than rᵤₘₐₓ.

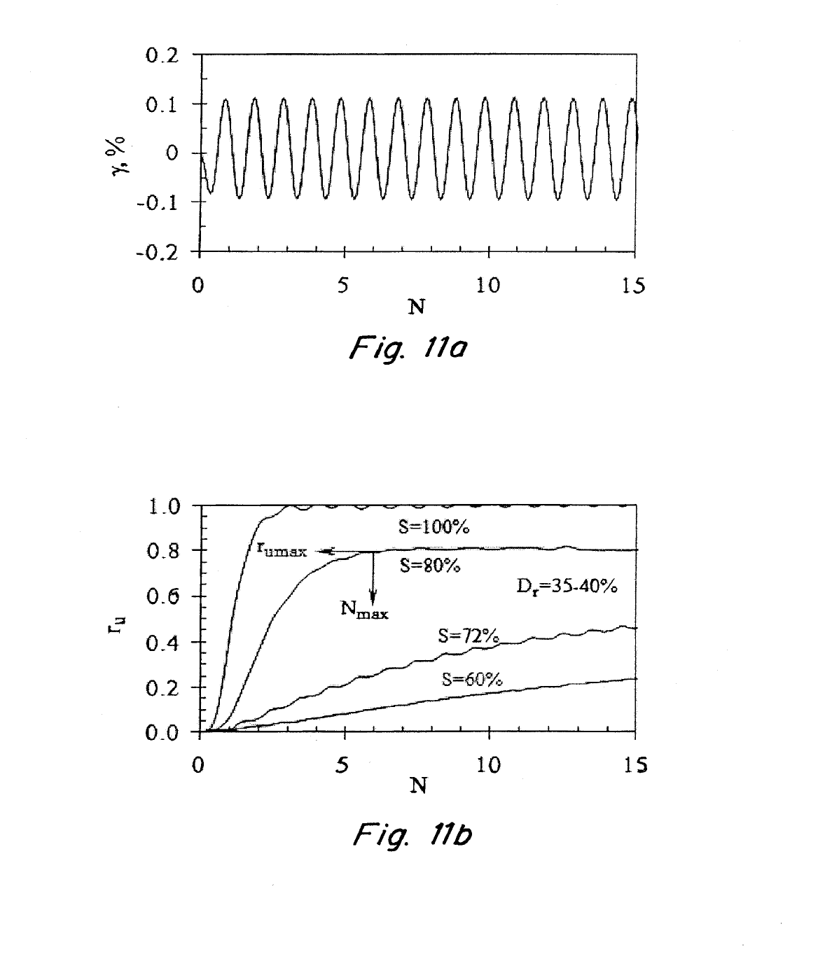

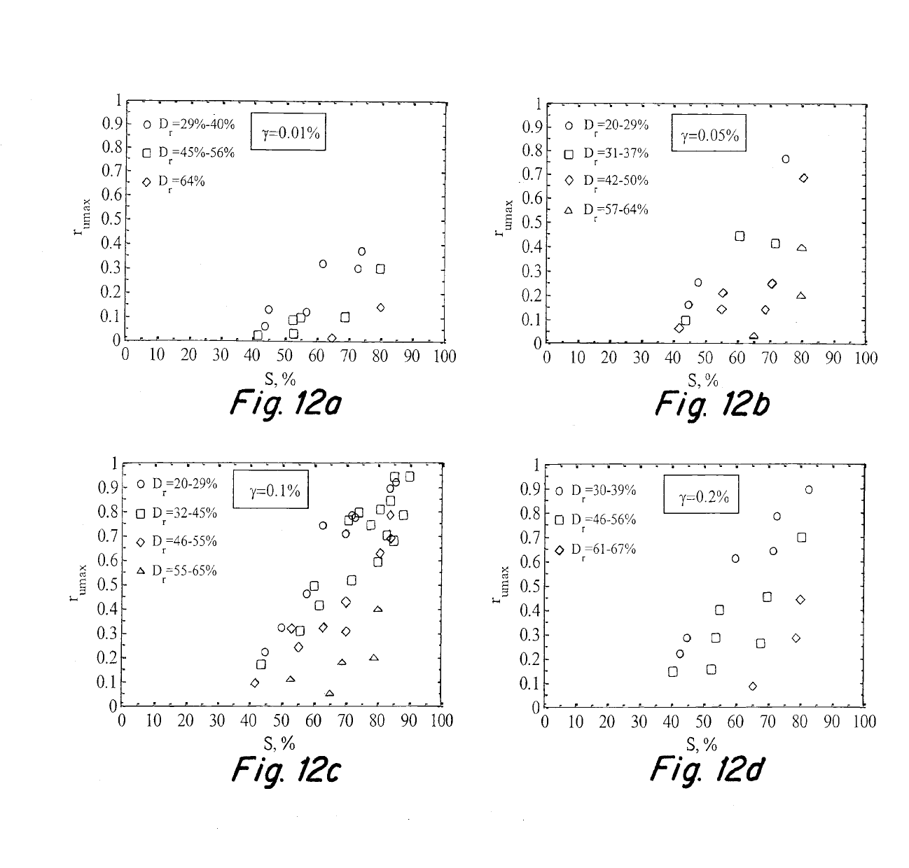

The entire set of test results (96 data) of rᵤₘₐₓ as a function of S, for different ranges of Dᵣ, and for γ of 0.01%, 0.05%, 0.1%, and 0.2% are presented in FIGS. 12(a)-12(d). The following additional observations can be made from the data: 1) For constant S and γ, the larger the relative density, the smaller the rᵤₘₐₓ; 2) For constant S and Dᵣ, the larger the strain amplitude, the larger the rᵤₘₐₓ.

In summary, partial degree of saturation, in accordance with exemplary embodiments, prevents the occurrence of initial liquefaction (rᵤₘₐₓ=1.0), and significantly reduces the excess pore pressure ratio (rᵤ) depending on the degree of saturation (S), relative density (Dᵣ), shear strain amplitude (γ) and number of cycles (N).

Whether partially saturated sand remain so on a long-term basis under varying ground water flow conditions and under ground shaking such as during an earthquake, was also investigated.

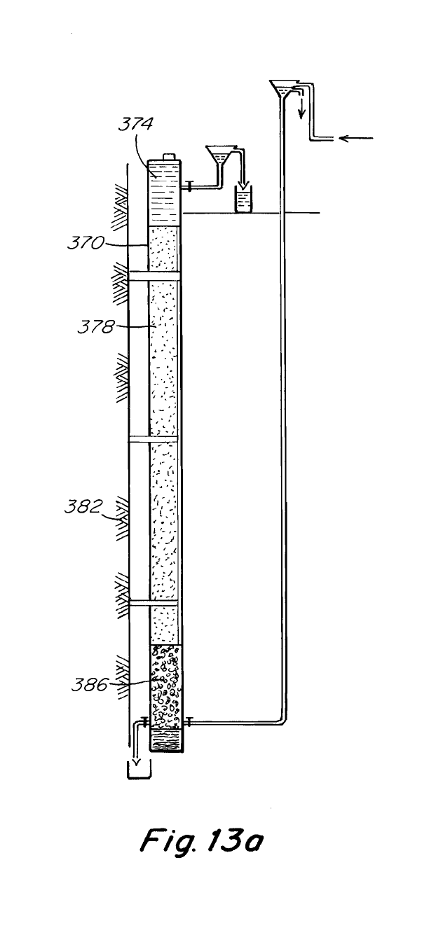

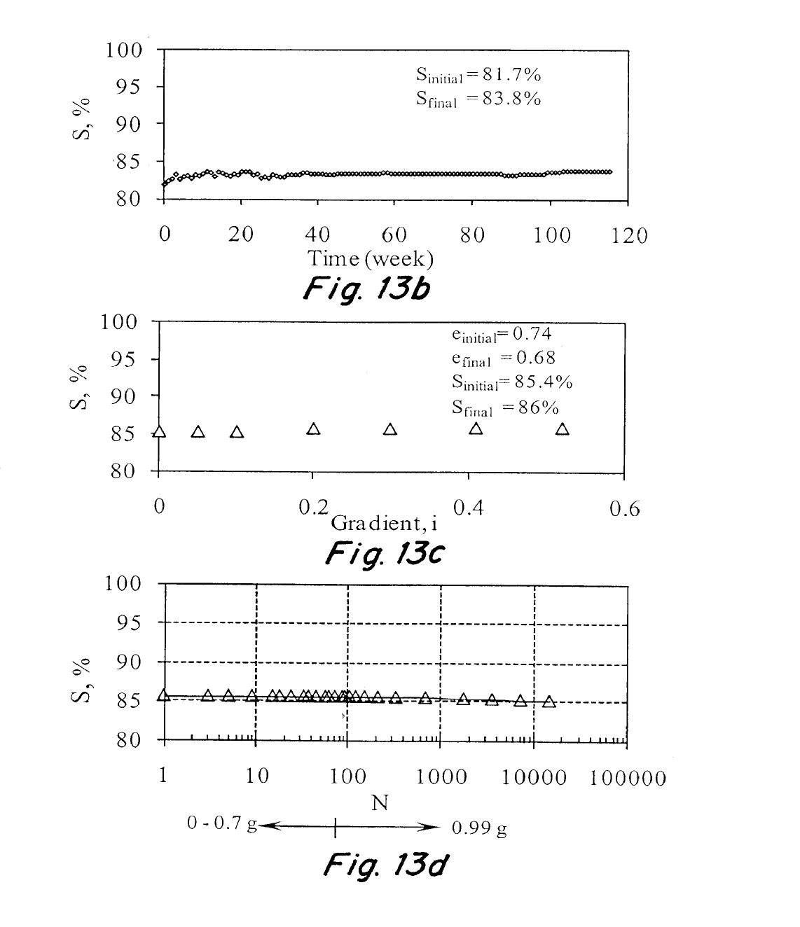

FIG. 13(a) shows one of the test setups in which partially saturated sand specimens were prepared in a Plexiglas tube 370 using a drainage-recharge technique. The test setup includes water 374, partially saturated sand 378, reinforced concrete 382 and a gravel filter 386. One of the tests conducted was to monitor partial degree of saturation under long-term hydrostatic conditions. FIG. 13(b) shows the results for 115 weeks, indicating that the average degree of saturation only slightly increased from 82% to 84% due to the escape of air bubbles from the top 5 cm of the specimen. Additional tests were conducted in a similar Plexiglas tube to monitor partial degree of saturation under vertical upward hydraulic gradients of i=0.01-0.52 applied at 30-hour intervals. The results shown in FIG. 13(c) demonstrate that the degree of saturation is unaffected by the upward flow through the partially saturation specimen. Sustainability of partial degree of saturation under horizontal cyclic base excitation was also investigated by vibrating the bottom of the test tube using a small shaking table. FIG. 13(d) shows that the degree of saturation in a partially saturated specimen did not change under base excitation of up to 1 g for over 10,000 cycles. In summary, partially saturated specimens, according to exemplary embodiments tested under hydrostatic conditions, upward flow gradients, and horizontal cyclic base excitation experienced only slight increase in degree of saturation (by less than 2%), indicating that partial degree of saturation in sands can be sustained on a long-term basis.

### Empirical Model

In accordance with an exemplary aspect of the present disclosure, an empirical model was developed to predict excess pore pressure ratio (rᵤ) in partially saturated sands subjected to earthquake-induced shear strains. The model is based on the above-noted experimental test results from partially saturated sands. To summarize, cyclic simple shear strain tests were performed on specimens prepared and tested in the liquefaction box 300. Excess pore pressures were measured for a range of degree of saturation S>40%, relative density Dᵣ=20-67%, and cyclic shear strain γ=0.01-0.2%. The test results demonstrated that partially saturated sands achieved a maximum excess pore pressure ratio (rᵤₘₐₓ) when large enough cycles of shear strain were applied. The excess pore pressure ratio (rᵤ) that a partially saturated sand can achieve under a given earthquake-induced peak shear strain and number of equivalent cycles of application can be significantly smaller than rᵤₘₐₓ. Therefore, the empirical model was developed in two stages. In the first stage, rᵤₘₐₓ was related to S, Dᵣ, and γ. In the second stage, a model was developed relating rᵤ to rᵤₘₐₓ, γ, effective stress (σᵥ′), and earthquake magnitude (M). Presented herein are the equations that define the predictive models for rᵤₘₐₓ and rᵤ. Using these equations, plots for rᵤₘₐₓ and rᵤ are provided for ranges of sand and earthquake parameters for ease of use in engineering applications. To illustrate the implementation of the empirical model for predicting rᵤₘₐₓ and rᵤ, an example is presented in which a partially saturated sand layer experiencing a peak earthquake-induced shear strain was analyzed, and the pore pressure response of the sand was evaluated both using the predictive equations and the plots.

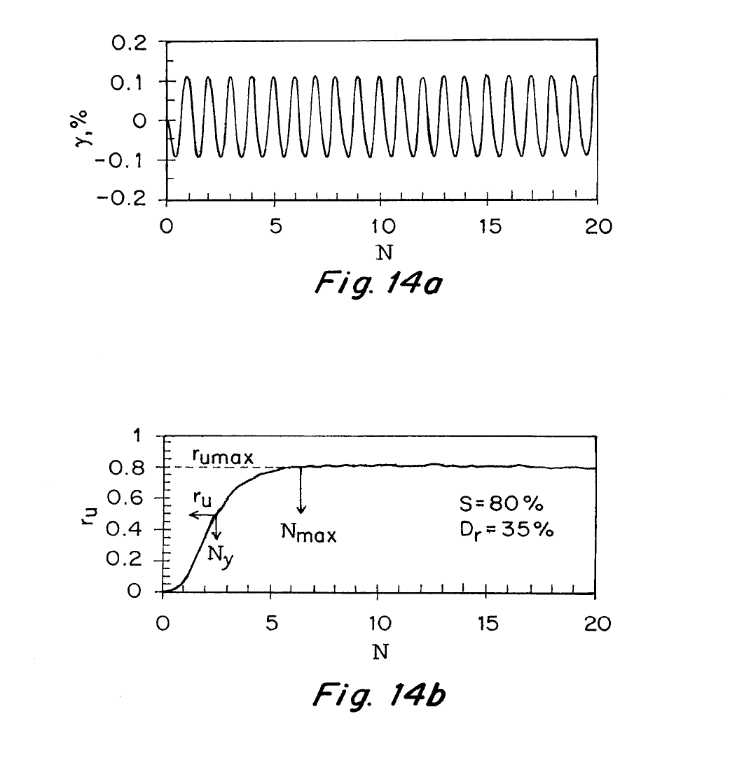

FIGS. 14(a)-14(b) are used to show typical excess pore pressure ratio generation in a partially saturated specimen as a function of number of cyclic strain (N). The parameters of interest in the formulation of the predictive model are as follows: degree of saturation (S), relative density, (Dᵣ), cyclic shear strain amplitude (γ), vertical effective stress (σ′v), maximum excess pore pressure ratio (rᵤₘₐₓ), number of cyclic shear strain at which rᵤₘₐₓ is achieved (Nₘₐₓ), excess pore pressure ratio (rᵤ), and number of equivalent cyclic shear strain associated with an earthquake strain time history (N_{γ}).

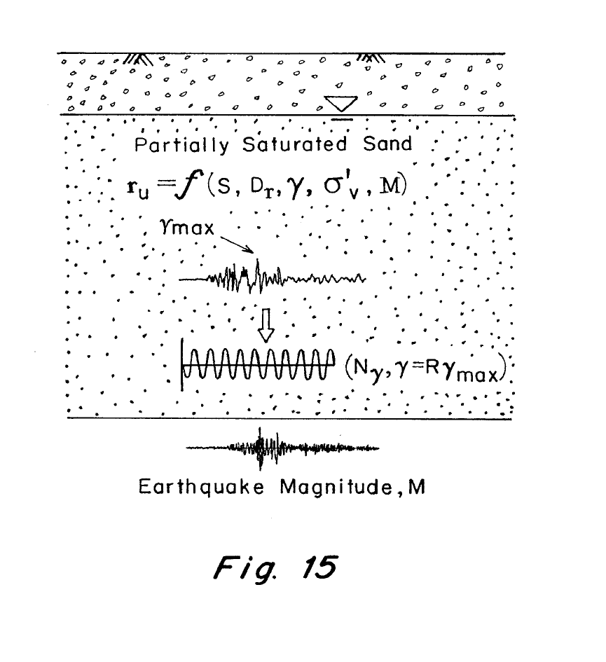

A goal of the development of the model was to provide a way for predicting excess pore pressure ratios (rᵤ) in partially saturated sands subjected to seismic shear strains. FIG. 15 depicts a sand profile of partially saturated sand experiencing ground motions associated with input acceleration of an earthquake with a magnitude (M). The output of the ground motion analysis at a given depth can be expressed in terms of a shear strain time-history with a peak shear strain amplitude of γₘₐₓ. To make use of the experimental results from the cyclic shear strain tests, noted above, this maximum shear strain has to be converted to an equivalent cyclic shear strain in a manner similar to the procedure followed for fully saturated sands. Strain ratio R=γ/γₘₐₓ where R can be expressed in terms of earthquake magnitude M (R=(M−1)/10). Using the strain ratio (R), the earthquake-induced strain time history can be converted to an equivalent number and amplitude of cyclic shear strains (N_{γ}, γ). Excess pore pressure ratio (rᵤ) then can be predicted using the empirical model developed based on the experimental test results. The number of equivalent cyclic shear strains (N_{γ}) can be estimated either from the shear strain time-history obtained from a ground motion analysis or using empirical data.

Development of the rᵤ predictive model for partially saturated sands was achieved in two stages:
1) The function ƒ₁ given in Eq. (6) was established relating rᵤₘₐₓ to: degree of saturation (S), relative density (Dᵣ) and equivalent cyclic shear strain (γ=γₘₐₓ×R).

rᵤₘₐₓ=ƒ₁(S, Dᵣ, γ) (6)
2) The function ƒ₂ given in Eq. (7) was established relating rᵤ (excess pore pressure ratio achieved during a given seismic event generating N_{γ}, number of equivalent cyclic shear strain (γ)) to rᵤₘₐₓ (maximum excess pore pressure ratio that can be achieved, if Nₘₐₓ number of cyclic shear strain are applied).

$$\frac{{r}_{u}}{{r}_{u max}} = {f}_{2} ( \frac{{N}_{γ}}{{N}_{max}} ) \qquad ( 7 )$$

As will be demonstrated, N_{γ}, can be related to R and M, while Nₘₐₓ can be expressed in terms of rᵤₘₐₓ, γ, and σ′ᵥ.

Finally, combining the above two functions, the final function (ƒ) that provides an estimate of rᵤ in a partially saturated sand subjected to a seismic excitation was established as shown in Eq. (8):

rᵤ=ƒ₁×ƒ₂=ƒ(S, Dᵣ, γ, σ′ᵥ, M) (8)

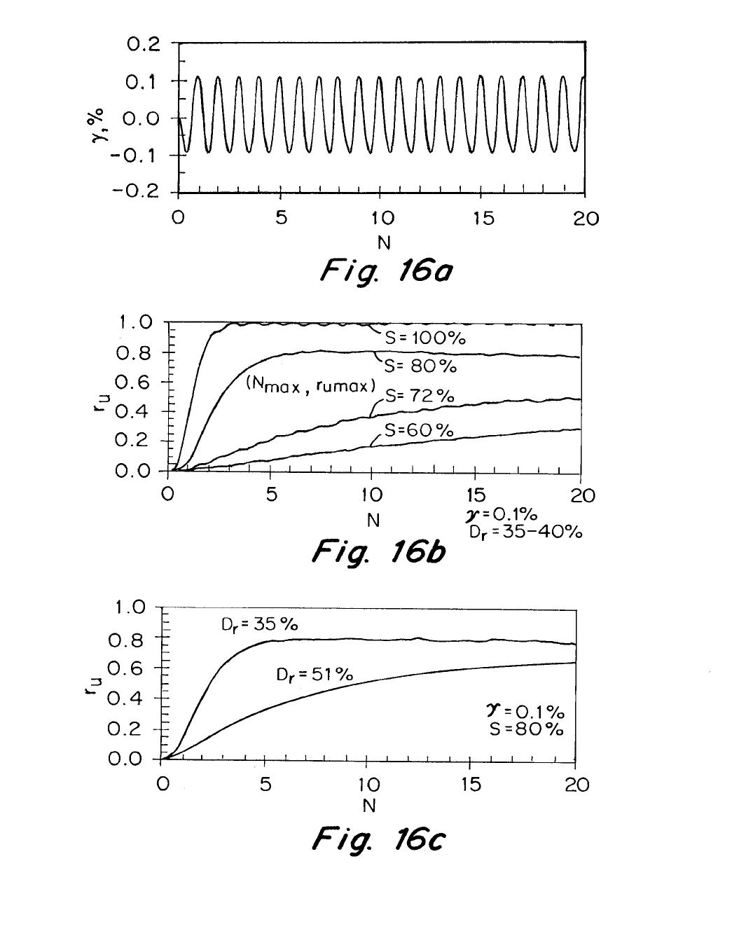

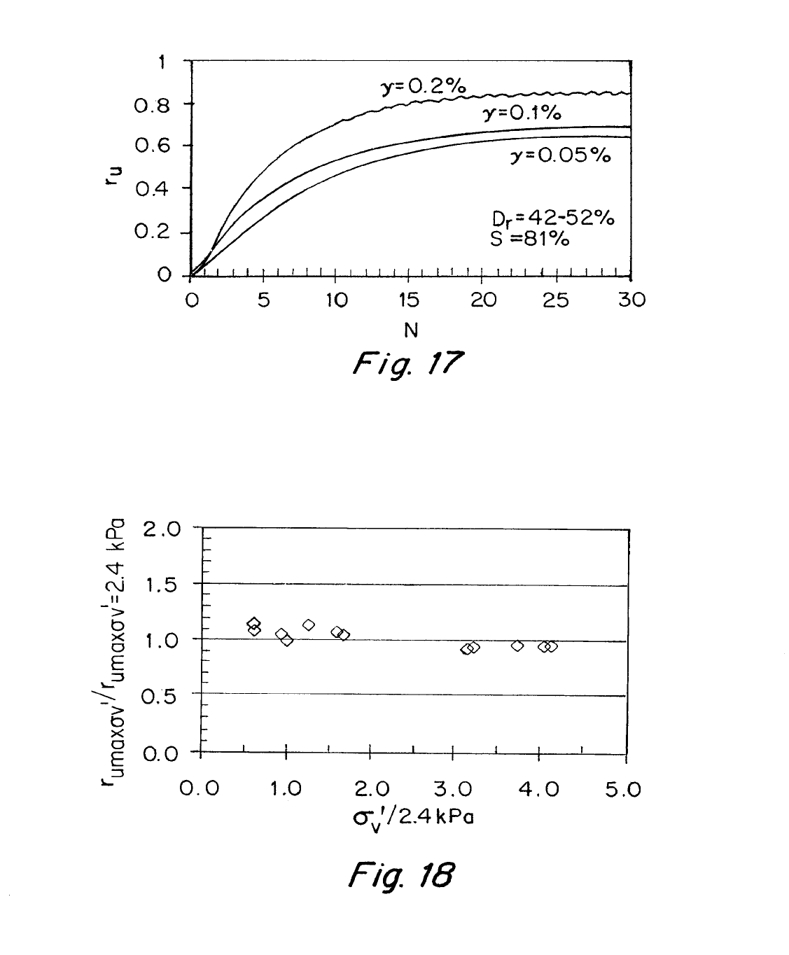

In order to investigate the effects of the parameters S, Dᵣ, γ, σ′ᵥ on rᵤ generation, cyclic shear strain tests were performed, as noted above, using the liquefaction box 300 and the loading mechanism, which is the shaking table 324. A total of 96 tests were performed, where the results of initial 24 tests were used to develop a preliminary understanding of behavior of partially saturated sands and to plan the details for the additional tests. Eventually, the entire set of data was used to develop the predictive model for rᵤ. The influence of each parameter on rᵤ was investigated, and the observations made were used to guide the development of the predictive model. FIGS. 15 through 17 show typical test results from which the following trends are observed:
1. FIG. 16(a) represents a typical cyclic shear strain record. For a given relative density Dᵣ=35-40% and a shear strain amplitude γ=0.1%, as the degree of saturation (S) is reduced, the excess pore water pressure ratio (rᵤ) decreases, as shown in FIG. 16(b). The lower the degree of saturation, the smaller is the rᵤₘₐₓ and the larger is the Nₘₐₓ. While at S=100%, rᵤₘₐₓ is 1.0; for S<100%, rᵤₘₐₓ is always smaller than 1, indicating that partially saturated sands can never achieve initial liquefaction (rᵤₘₐₓ=1).
2. Test results shown in FIG. 16(c) demonstrate that relative density has a significant influence on the rate of generation of excess pore pressure. The denser the sand, the slower the rate of increase in rᵤ. Also, as the density of the sand increases, rᵤₘₐₓ decreases and Nₘₐₓ increases.
3. The experimental results shown in FIG. 17 demonstrate that as the shear strain amplitude increases, the maximum value of ru, rᵤₘₐₓ increases and the number of cycles required to reach rᵤₘₐₓ (Nₘₐₓ) decreases. The effect of shear strain amplitude on rᵤₘₐₓ is smaller than that of S and Dᵣ.
4. The effect of σ′ᵥ on rᵤₘₐₓ was also investigated. FIG. 18 shows rᵤₘₐₓ under different σ′ᵥ compared with rᵤₘₐₓ at σ′ᵥ=2.4 kPa. The results show that initial effective stress has little influence on rᵤₘₐₓ. Although the range of σ′ᵥ used in the experiments was rather small because of limitations in size of a specimen and the test set up, the results observed show a similar trend as in fully saturated sands where rᵤₘₐₓ=1 independent from σ′ᵥ.

These and other observations from the experimental test results were used to develop the model for predicting excess pore pressure ratio (rᵤ) in partially saturated sands during earthquakes.

Prediction of Maximum Excess Pore Pressure Ratio (ruₘₐₓ)

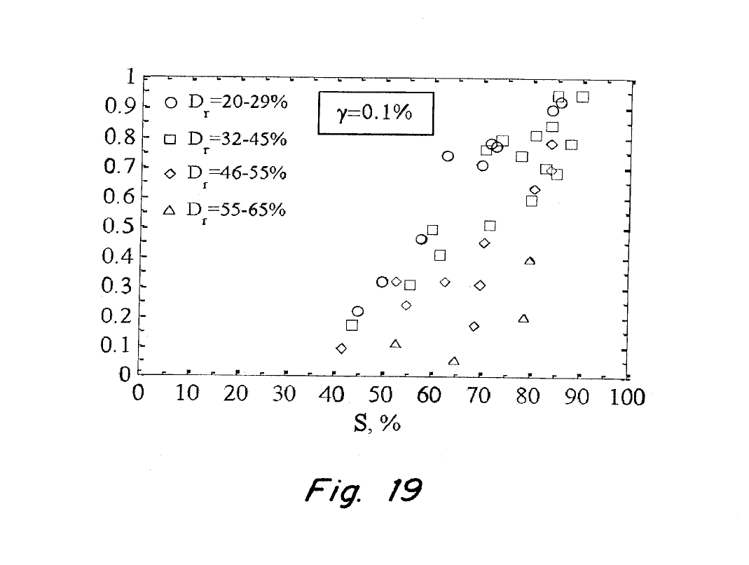

If a partially saturated sand specimen with a certain relative density is subjected to a cyclic shear strain amplitude of γ, after a certain number of cycles (Nₘₐₓ) the excess pore pressure ratio will reach a maximum value of rᵤ=rᵤₘₐₓ. As noted above, test results on partially saturated specimens showed that rᵤₘₐₓ depends significantly on the degree of saturation (S) and to a lesser extend on relative density (Dᵣ) and amplitude of the cyclic shear strain (γ). FIG. 19 shows further test results confirming that S has a more important influence on rᵤₘₐₓ than Dᵣ. Since S is observed to be the most dominant parameter, the formulation of a model for predicting rᵤₘₐₓ was first based on establishing an equation that related rᵤₘₐₓ to only S for sand in its loosest condition (Dᵣ=20%) and for a shear strain amplitude of γ=0.1%. This equation is referred to as “the base function ƒ_{b}”. Then, a scaling factor function “F_{D}” was established to relate rᵤₘₐₓ generated at Dᵣ=20% to relative densities greater than 20%. Similarly, a scaling factor function “F_{γ},” was developed to relate rᵤₘₐₓ generated at a shear strain of 0.1% to other levels of shear strain amplitudes. The final rᵤₘₐₓ model function ƒ₁ (Eq. (6)) was obtained by the product of the base function ƒ_{b} and the scaling factor functions F_{D} and F_{γ} as in Eq. (9):

rᵤₘₐₓ=ƒ₁(S, Dᵣ, γ)=ƒ_{b}(S, Dᵣ=20%, γ=0.1%)×F_{D}(S, Dᵣ)×F_{γ}(S, l γ) (9)

The base function ƒ_{b} and the scale factor functions E_{D} and F_{γ} were established ultimately using all 96 data points on partially saturated sand specimens with parameters ranging: S=40-90%, Dᵣ=20-67%, and γ=0.01-0.2%. The results of these analyses led to the following functions that relate rᵤₘₐₓ to S, Dᵣ, and γ.

$$\begin{matrix}{f}_{b} = {S}^{0.5} \times {e}^{- {[ \frac{1 - S}{0.54} ]}^{4}} & ( 10 ) \\ {F}_{D} = 1 - 8.75 \times ( {D}_{r} - 0.2 ) \times ( 1 - S ) \times {e}^{[ \frac{{( 1 - S )}^{2}}{2 \times ( 1 - 0.84 \times ( \frac{0.2}{{D}_{r}} ) 0.25 ) 2} ]} & ( 11 ) \\ {F}_{γ} = 1 - 1.75 \times ( - log \frac{γ}{0.001} ) \times ( 1 - S ) \times {e}^{[ - 3.1 {( 1 - S )}^{2} ]} & ( 12 )\end{matrix}$$

Note that F_{D}=1 for Dᵣ=20%, and F_{γ}=1 for γ=0.1%

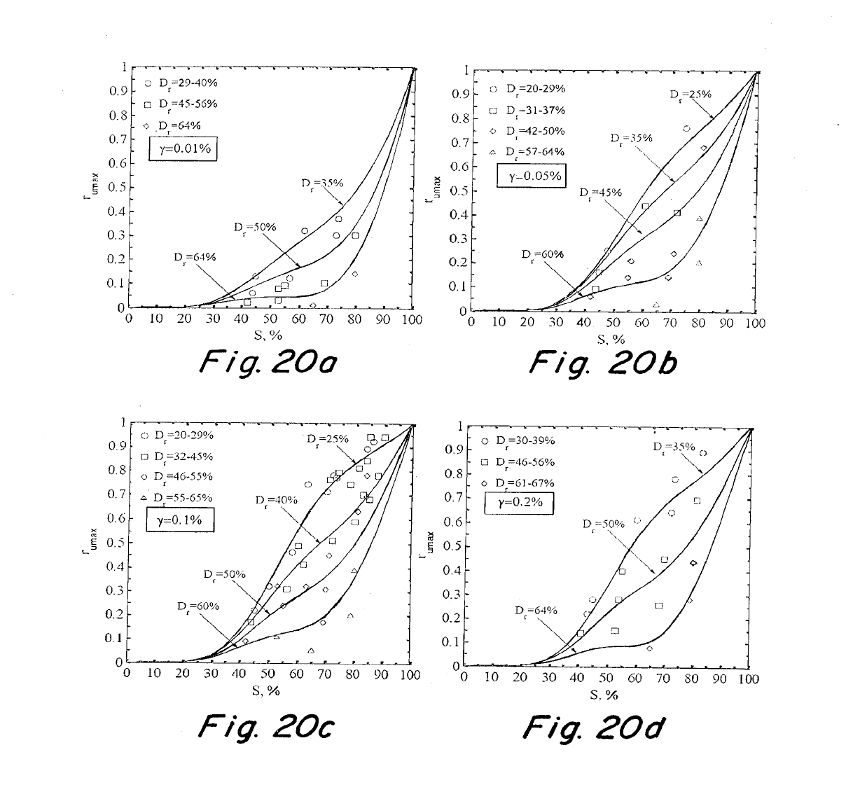

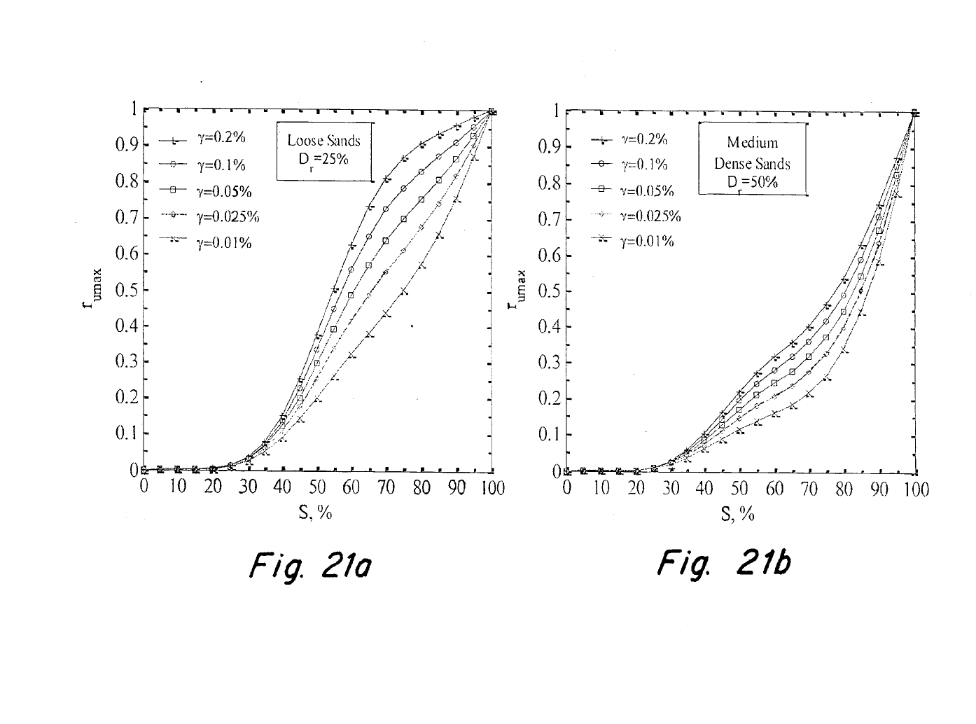

Model adequacy or the goodness of fit was evaluated by calculating mean square error (MS=0.007) and coefficient of determination (R²=0.92) for all the 96 test data. The low mean square error and the high coefficient of determination demonstrate that the predicted rᵤₘₐₓ values from the model are in good agreement with the experimental data. In FIGS. 20(a)-(d) comparisons are made between the experimental data and the rᵤₘₐₓ values predicted by the model shown in Eqs. (9)-(12). Because of the complexity of the equations of the predictive model, for ease of estimation, two plots of rᵤₘₐₓ were generated for partially saturated loose (Dᵣ=25%) and medium dense (Dᵣ=50%) sands, for varying levels of shear strain, as shown in FIGS. 21(a) and 21(b). It is noted that these plots provide estimates of rᵤₘₐₓ assuming that the sand is subjected to enough numbers of cyclic shear strains (Nₘₐₓ) with amplitude γ to achieve rᵤₘₐₓ. If the number of equivalent cycles of a seismic shear strain history is fewer than Nₘₐₓ, then the excess pore pressure ratio (rᵤ) will be smaller than rᵤₘₐₓ. Next, a predictive model for rᵤ is presented.

### Prediction of Excess Pore Pressure Ratio (ru)

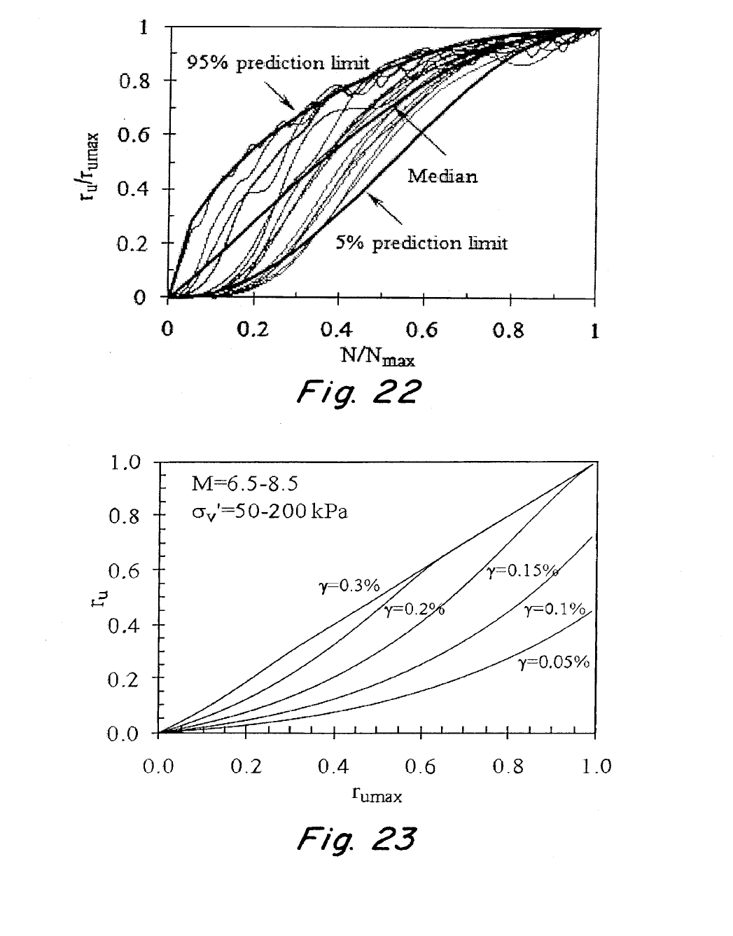

As noted above, an empirical model (f₁) was presented that can be used to predict maximum excess pore pressure ratio (rᵤₘₐₓ) in partially saturated sands. The model assumes that the number of cycles of application of shear strain is large enough to achieve the maximum value of excess pore pressure ratio. However, earthquakes with different magnitudes will apply different numbers of equivalent cyclic shear strains (N_{γ}). Hence, if the magnitude of a design event is small enough that N_{γ} is less than Nₘₐₓ then rᵤ will be less than rᵤₘₐₓ, as shown in FIG. 14. To evaluate the rate of increase of rᵤ with the number of cyclic shear strain, the test results from rᵤ were normalized with rᵤₘₐₓ and plotted versus N/Nₘₐₓ, as shown in FIG. 22. The slight variation in the rates of excess pore pressure generation could be because of secondary influences of S, Dᵣ, and γ beyond what is shown in Eq. (6).

To establish a model for the estimation of rᵤ, a function ƒ₂ was established using the normalized rᵤ/rᵤₘₐₓ versus N/Nₘₐₓ plots of FIG. 22. As defined earlier, N_{γ}, is the number of equivalent cyclic shear strain associated with a seismic event, and hence N_{γ}, can be used as N in FIG. 22 to obtain rᵤ/rᵤₘₐₓ. The trigonometric function shown in Eq. (13) was determined to be best suited to describe the trends observed in the data shown in FIG. 22.

$$\frac{{r}_{u}}{{r}_{u max}} = {f}_{2} ( \frac{{N}_{γ}}{{N}_{max}} ) = {( \frac{sin [ ( \frac{{N}_{γ}}{{N}_{max}} - 0.5 ) \times π ] + 1}{2} )}^{θ} \qquad ( 13 )$$

Based on a statistical analysis of the data, upper bound (95% prediction limit), median, and lower bound (5% prediction limit) functions were established resulting in values of the parameter 0 in Eq. (13) of 0.25, 0.54, and 1.1, respectively. FIG. 22 includes these limit lines.

The number of equivalent cyclic shear strain N_{γ}, can be obtained either using the shear strain record computed through a ground motion analysis of the sand profile in a way similar to that followed for a fully saturated sand or empirically by using strain ratio (R) and earthquake magnitude (M).

The predictive model for rᵤ presented herein uses an empirically estimated N_{γ}. The development of the procedure for estimating N_{γ} involved relating the number of equivalent cyclic shear strains for R=0.65 to M, using the data from Seed et al. (1975) (Seed, B., Idriss, I., Makdisi, F., and Banerjee, N. (1975). “Representation of irregular stress time histories by equivalent uniform stress series in liquefaction analyses.” Earthquake Engineering Research Center (EERC) California.) Based on a regression analysis of the data the following relationship was established.

N_{γ}(R=0.65)=0.057e^{0.72M} (14)

To estimate N_{γ} for any R value, the data of Astunias and Dobry (1982) was used relating N_{γ} (R=R) to N_{γ} (R=0.65) as shown in Eq. (15). (Dobry, R. Ladd, R. S., Yokel, F. Y., Chung, R. M., Powell, D. (1982). “Prediction of pore water pressure buildup and liquefaction of sands during earthquakes by the cyclic strain method.” U.S. Dept. of Commerce, Washington, D.C., 152.)

$$\frac{{N}_{γ} ( R = R )}{{N}_{γ} ( R = 0.65 )} = 0.114 \times {e}^{{( \frac{1}{R} )}^{1.8}} \qquad ( 15 )$$

Combining Eqs. (14) and (15) leads to:

$${N}_{γ} ( R = R ) = 0.114 \times {e}^{{( \frac{1}{R} )}^{1.8}} \times 0.057 {e}^{0.72 M} \qquad ( 16 )$$

Using an expression to relate R to M (R=(M−1)/10), Eq. (16) can be expressed only in terms of earthquake magnitude (M) as in Eq. (17).

$${N}_{γ} = 0.0065 \times {e}^{[ {( \frac{10}{M - 1} )}^{1.8} + 0.72 M ]} \qquad ( 17 )$$

The number of cyclic shear strain at which rᵤₘₐₓ is achieved (Nₘₐₓ) was observed to be dependent on S, Dᵣ, γ and σ′ᵥ. Since rᵤₘₐₓ incorporates the effects of S, Dᵣ and γ, it was decided to relate Nₘₐₓ to rᵤₘₐₓ and σ′ᵥ. Since partially saturated specimens were tested under relatively small σ′ᵥ=2.5 kPa, the effect of larger σ′ᵥ on Nₘₐₓ was introduced in a similar way as for number of cycles to liquefaction (N_{L}) in fully saturated sands. Eq. (18) shows the expression that relates Nₘₐₓ to rᵤₘₐₓ, γ, and σ′ᵥ. σ′ᵥ is in kPa.

$${N}_{max} = 107 \times {e}^{( 3 {r}_{u max} + 2011 γ )} ( \frac{1}{kPa} ) \times {σ}_{v}^{′} \qquad ( 18 )$$

In summary, rᵤ can be estimated following these three steps:

Step 1: Compute maximum excess pore pressure ratio (rᵤₘₐₓ) from function ƒ₁ using Eqs. (4)-(7)

Alternatively, the plots in FIG. 21 for loose and medium dense sands can be used to estimate rᵤₘₐₓ for Dᵣ=25% and 50%. For other Dᵣ values, linear interpolation between the two plots is suggested. These plots were generated using Eqs. (9)-(12).

Step 2: Compute rᵤ/rᵤₘₐₓ for a given earthquake event from function ƒ₂ using Eqs. (13)-(18)

Step 3: Compute excess pore pressure ratio (rᵤ) from function ƒ=ƒ₁×ƒ₂

Alternatively, FIG. 23 can be used for a conservative estimate of rᵤ. The plots were generated using Eq. (13) with θ=0.25, and Eqs. (17) and (18). It is noted that M has little effect on the rᵤ plots because it has little effect on N_{γ}. The larger the M, the larger is the R, thus compensating the effect of M on N_{γ}. However, σ′ᵥ has appreciable effect on rᵤ. The plots are generated using σ′ᵥ=50 kPa. Under larger σ′ᵥ, the rᵤ values will be smaller than what the plots in FIG. 22 indicate.

### Example Application of Model

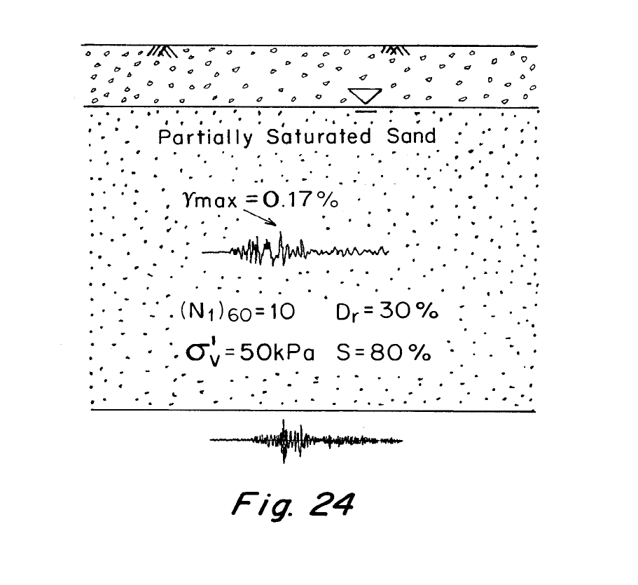

To illustrate the steps involved in estimating earthquake-induced excess pore pressure ratio (rᵤ) in a partially saturated sand layer where partial saturation is naturally occurring or induced for liquefaction mitigation, the following example is presented. The sand and the ground motion parameters are shown in FIG. 24.

The two-step procedure summarized in the previous section is implemented as follows:

$$Step 1 \text{:} Compute {r}_{umax} \text{:}$$

$$R = \frac{( 7 - 1 )}{10} = 0.6$$

$$γ = 0.6 \times 0.0017 = 0.1 \%$$

$$From Eqs . ( 9 ) \text{-} ( 12 ) \text{:}$$

$${r}_{umax} = {f}_{b} ( S , {D}_{r} = 20 \% , γ = 0.1 \% ) \times {F}_{D} ( S , {D}_{r} ) \times {F}_{γ} ( S , γ )$$

$${f}_{b} = {0.8}^{0.5} \times {e}^{- {[ \frac{1 - 0.8}{0.54} ]}^{4}} = 0.878$$

$${F}_{D} = 1 - 8.75 \times ( 0.3 - 0.2 ) \times ( 1 - 0.8 ) \times {e}^{[ \frac{{( 1 - 0.8 )}^{2}}{2 \times {( 1 - 0.84 \times {( 0.2 / 0.3 )}^{0.25} )}^{2}} ]} = 0.876$$

$${F}_{γ} = 1 - 1.75 \times ( - log \frac{0.001}{0.001} ) \times ( 1 - 0.8 ) \times {e}^{[ - 3.1 {( 1 - 0.8 )}^{2} ]} = 1.0$$

$${r}_{umax} = 0.878 \times 0.876 \times 1.0 = 0.77$$

Alternatively, from FIG. 20 for Dᵣ=25%, rᵤₘₐₓ=0.83 and Dᵣ=50%, rᵤₘₐₓ=0.49. For Dᵣ=30%, when interpolated between Dᵣ=25% and 50% plots, rᵤₘₐₓ=0.76, which is in good agreement with the value computed from Eqs. (9)-(12).

Step 2 Compute rᵤ/rᵤₘₐₓ

From Eqs. (13), (16), and (17):

$${N}_{γ} = 0.0065 \times {e}^{[ {( \frac{10}{7 - 1} )}^{1.8} + 0.72 ( 7 ) ]} ≅ 12 cycles$$

$${N}_{max} = 107 \times {e}^{- ( 3 ( 0.77 ) + 2011 ( 0.001 ) )} ( \frac{1}{kPa} ) \times 50 ≅ 71 cycles$$

$$\frac{{r}_{u}}{{r}_{umax}} = {( \frac{sin [ ( 12 / 71 - 0.5 ) \times π ] + 1}{2} )}^{θ}$$

Using θ=0.25 and 0.54 the upper bound and average values of rᵤ/rᵤₘₐₓ are 0.51 and 0.24.

Step 3 Compute rᵤ

From Eq. (3):

$${r}_{u} = {r}_{umax} ( \frac{{r}_{u}}{{r}_{u max}} )$$

rᵤ=0.77×0.51=0.4 (upper bound)

rᵤ=0.77×0.24=0.18 (average)

Alternatively, from the plots of FIG. 22, for rᵤₘₐₓ=0.77 and γ=0.1%, rᵤ is estimated to be 0.4.

In summary, the partially saturated sand layer in the example presented with S=80% and Dᵣ=30%, during an earthquake with M=7 causing a maximum (peak) shear strain of 0.17%, will not liquefy, but may experience excess pore pressure ratio of up to rᵤ=0.4. Excess pore pressures generated in partially saturated sands can be of importance in geotechnical earthquake engineering in the estimation of sand strength and settlement.

Exemplary aspects and embodiments of the invention being thus described, it will be apparent that the same may be varied in many ways. Such variations are not to be regarded as a departure from the spirit and scope of the embodiments and aspects, and all such modifications as would be recognized by one skilled in the art are intended to be included within the scope of the following claims

We claim:

1. A system for providing a partial level of saturation to a mass of sand, the system comprising:
a solution that is operable to generate gas bubbles;
a solution generator that prepares the solution; and
a conduit that delivers the solution to sand;
wherein the solution generates the gas bubbles after being delivered to the sand.

2. The system of 1, wherein the sand is assessed to determine whether it is susceptible to liquefaction before the solution is delivered to the sand.

3. The system of claim 1, wherein the conduit is disposed to deliver the solution to an area of the sand that is expected to be subjected to an earthquake.

4. The system of claim 1, wherein the solution comprises a mixture of sodium perborate and a liquid.

5. The system of claim 1, wherein the conduit comprises a pipe.

6. The system of claim 1, comprising a pump that forces the solution to the sand.

7. The system of claim 1, wherein the solution generator comprises a mixer.

8. The system of claim 1, wherein the solution generator comprises a chiller.

9. The system of claim 1, comprising an injection well that includes the conduit.

10. The system of claim 1, wherein the conduit extends beneath an existing structure.

11. The system of claim 1, wherein conduit extends beneath a site where a structure will be provided.

12. The system of claim 4, wherein the liquid is water.

13. The system of claim 6, comprising a water storage area in communication with the pump and solution generator.

14. The system of claim 10, wherein the structure is selected from a group consisting of a building, bridge, fluid storage tank, and dam.

15. The system of claim 11, wherein the structure is selected from a group consisting of a building, bridge, fluid storage tank, and dam.

16. The system of claim 13, comprising an extraction well that provides the water.

17. A method of providing a partial level of saturation to a mass of sand, the method comprising:
preparing a solution that generates gas bubbles; and
delivering the solution through a conduit to sand so that the gas bubbles are generated after the solution is within the sand.

18. The method of claim 17, wherein before the solution is delivered through the conduit, the sand is assessed to determine whether it is susceptible to liquefaction.

19. The method of claim 17, wherein sodium perborate is dissolved in a liquid to create the solution.

20. The method of claim 17, wherein the solution is forced to flow to the sand by a pump.

21. The method of claim 17, comprising using an injection well to circulate the solution into the sand followed by using an extraction well to extract at least a portion of the solution from the sand.

22. The method of claim 17, wherein the solution is delivered beneath an existing structure.

23. The method of claim 17, wherein the solution is delivered beneath a site of where a structure will be built.

24. The method of claim 17, wherein the solution includes water.

25. The method of claim 17, comprising manipulating the delivery of the solution so that a predetermined zone of sand is treated.

26. The method of claim 25, wherein multiple conduits are used to deliver the solution and the manipulating includes controlling which conduct has solution flowing therethrough.

27. The method of claim 17, wherein the manipulating includes controlling the rate of flow of the solution.

28. The method of claim 22, wherein the structure is selected from a group consisting of a building, bridge, fluid storage tank, and dam.

29. The method of claim 23, wherein the structure is selected from a group consisting of a building, bridge, fluid storage tank, and dam.

30. A probe for determining a level of partial saturation in sand, the probe comprising:
a housing;
an actuator that induces vibration to the housing;
a chamber inside of the housing that includes a liquid; and
a pressure transducer to measure change in pressure of the liquid.

31. The probe of claim 30, wherein a flexible sealant is provided around a periphery of the housing.

32. The probe of claim 30, wherein the housing comprises a first end and a second end, the second end having a conical shape.

33. The probe of claim 30, wherein a porous material is provided around at least a portion of the chamber.

34. The probe of claim 33, wherein the porous material is stone.
